(19) United States
(12) Patent Application Publication
(10) Pub. No.: US 2020/0187480 A1
(43) Pub. Date: Jun. 18, 2020

(54) MULTI-PRONG IMMOBILIZING FISHING GAFF AND ASSOCIATED METHODS

(71) Applicant: Derek Adams, Savannah, GA (US)

(72) Inventor: Derek Adams, Savannah, GA (US)

(21) Appl. No.: 16/690,920

(22) Filed: Nov. 21, 2019

Related U.S. Application Data
(60) Provisional application No. 62/770,703, filed on Nov. 21, 2018.

(51) Int. Cl. A01K 97/14

(52) U.S. Cl. CPC A01K 97/14

(57) ABSTRACT

An improved multi-prong gaff and associated methods for immobilizing a caught fish including providing a metallic head having a centrally disposed body, and further having at one end a first projection point for engaging the fish, and a handle engaging portion at the second end, and at least one immobilizing, pointed projection disposed on the body and projecting inwardly of the body and substantially parallel to the first and second projections.

### CROSS-REFERENCE TO RELATED APPLICATIONS

This application claims priority to U.S. Provisional Patent Application No. 62/770,703, filed Nov. 21, 2018, which is hereby expressly incorporated herein by reference in its entirety for any purpose.

### FIELD OF THE INVENTION

Embodiments of the disclosure are directed generally to fishing gear, and, more particularly, to an improved multi-prong gaff for immobilizing a caught fish and associated methods thereof.

### BACKGROUND OF THE INVENTION

Most conventional fishing gaffs are typically adapted for the specific task of retrieving a hooked and otherwise landable fish from the water. Gaffs are most often used when the weight of the fish exceeds the breaking point of the fishing line or the fishing pole.

In general, a fishing gaff comprises a pole with a sharp hook on the end that is used to “hook” a large fish, and then to lift the fish into the boat or onto the shore. Ideally, the hook is placed under the backbone of the caught fish. A gaff cannot be used if it is intended to release the fish unharmed after capture, unless the fish is skillfully gaffed in the lip, jaw, or lower gill using a thin gaff hook.

Other types of gaffs may be used, such as a “flying gaff”, which is a specialized type of gaff used for securing and controlling very large fish. The hook part of the gaff (the head) detaches when sufficient force is used, somewhat like a harpoon's dart. The head is secured to the boat with a length of heavy rope or cable.

Another attempt to solve these problems has been the “Australian-style” or squared gaff which seeks to position or wedge the fish more securely within the gap of the gaff hook, and not fall out, which can occur with barbless round-bend gaffs.

But, however, certain problems continue to exist with prior art gaffs which have not been satisfactorily addressed, ameliorated or solved. Specifically, the fish may squirm, flip or turn, and thereby become disengaged from these prior art gaffs, which often will result in loss of the fish. Barbed gaffs may be used, but have the further disadvantage of difficulty of disengagement from the fish when successfully secured within the boat.

Accordingly, it is a fundamental purpose of the improved multi-prong gaff of the present invention to reduce and/or eliminate problems associated with prior art gaff structures by substantially securing and immobilizing the fish once it is disposed with the mouth of the gaff.

It is a yet further purpose of the improved multi-prong gaff of the present invention to provide an immobilizing member disposed within the mouth of the gaff body to prevent the fish from torqueing or turning, once gaffed.

### Summary of the Disclosure

The improved multi-prong gaff of the present invention functions to firmly secure and to immobilize a caught fish. The improved multi-prong gaff includes a metallic head having a centrally-disposed body which may be of various shapes, and preferably substantially in the shape of substantially a semi-circle, to form a gaff “mouth”. The gaff body has a handle engaging end and, at the opposite end, a sharp first projection for engaging or hooking the fish, and at least one sharp immobilizing projection member disposed on the body, projecting inwardly of the body and substantially parallel to the first projection to provide supplemental hooking of the fish.

### BRIEF DESCRIPTION OF THE DRAWING

Those skilled in the art will appreciate the above features and advantages, as well as additional features and advantages upon reading the following detailed description with reference to the accompanying drawings and appendix.

FIG. 1 is a perspective view of a typical prior art gaff head, showing a metallic centrally-disposed body, often substantially in the shape of a semi-circle, and further having at one end a pointed first projection for engaging the fish and a second projection for engaging a handle;

FIGS. 2A, 2B, 2C are respectively side and end views of the head of the improved multi-prong gaff of the present invention, showing a metallic centrally-disposed body which in some preferred embodiments may be substantially in the shape of a semi-circle, and further having at one end a pointed first projection for engaging the fish, and having a single pointed immobilizing projection disposed on the body, and projecting inwardly of the semi-circular body and substantially parallel to the first and second projections of the body;

FIGS. 3A, 3B, 3C are respectively side and end views of an alternative embodiment of the head of the improved multi-prong gaff of the present invention, showing a metallic centrally-disposed body shown in this embodiment substantially in the shape of a semi-circle, and further having at one end a pointed first projection for engaging the fish, and having pointed dual immobilizing projections disposed on the body, and projecting inwardly of the semi-circular body and substantially parallel to the first and second projections of the body;

FIG. 4 is a side view of a yet further preferred embodiment of the improved multi-prong gaff of the present invention, showing a reinforcing member attached to the body of the gaff and bearing thereon one of the immobilizing pointed projections; and

FIG. 5 is a fragmented cross-sectional side view of one form of a gaff handle, having a connection portion deposed at the distal end thereof and a grasping portion disposed at the proximal end thereof for gasping manually in order to manipulate the head for carrying out an immobilizing gaffing function.

### DETAILED DESCRIPTION

Referring now to the Drawing in which like numerals indicate like parts throughout the several views, the FIGS. illustrate preferred and alternative embodiments of the improved multi-prong immobilizing fishing gaff of the present invention.

The following description is provided as an enabling teaching of exemplary embodiments, and those skilled in the relevant art will recognize that changes can be made to the embodiments described. It also will be apparent that some of the desired benefits of the embodiments described can be obtained by selecting some of the features of the embodiments without utilizing other features. Accordingly, those skilled in the art will recognize that modifications and adaptations to the embodiments described are possible and may even be desirable in certain circumstances, and are a part of the invention. Thus, the following description is provided as illustrative of the principles of the embodiments and not in limitation thereof.

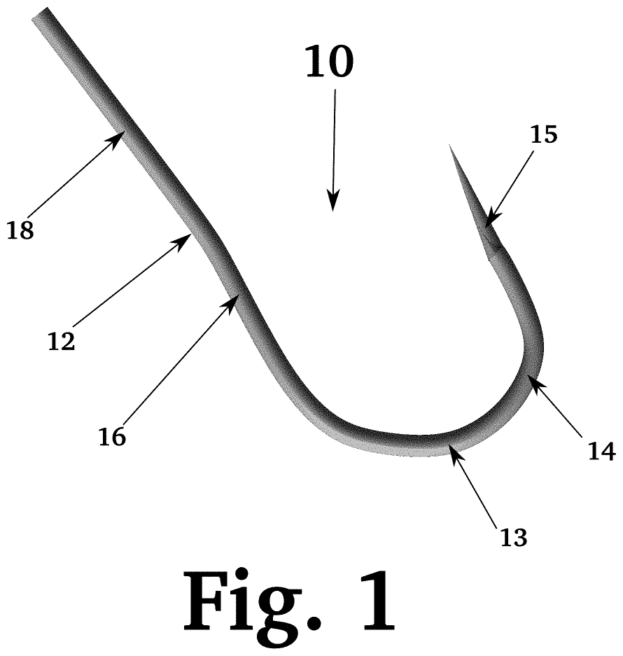

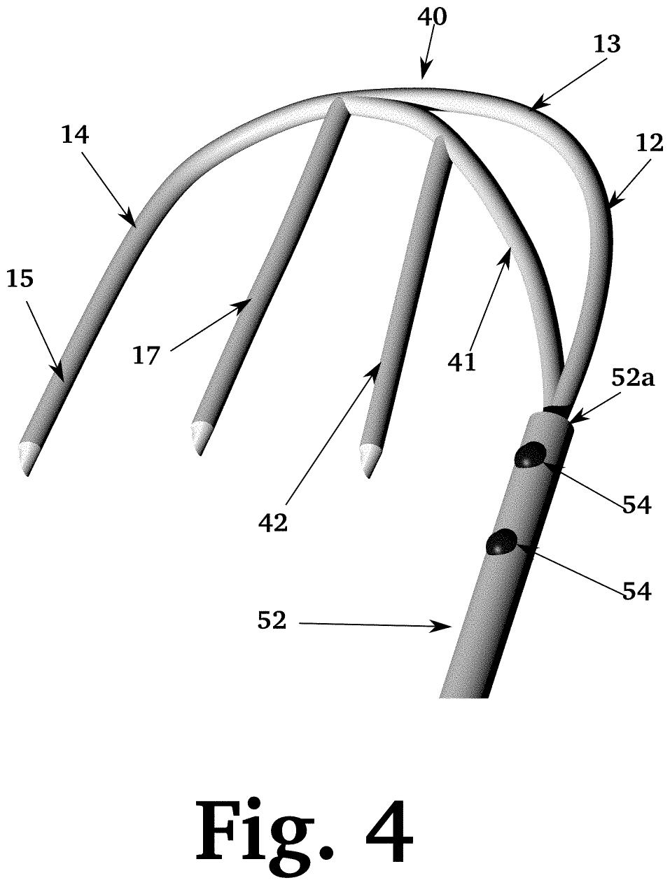

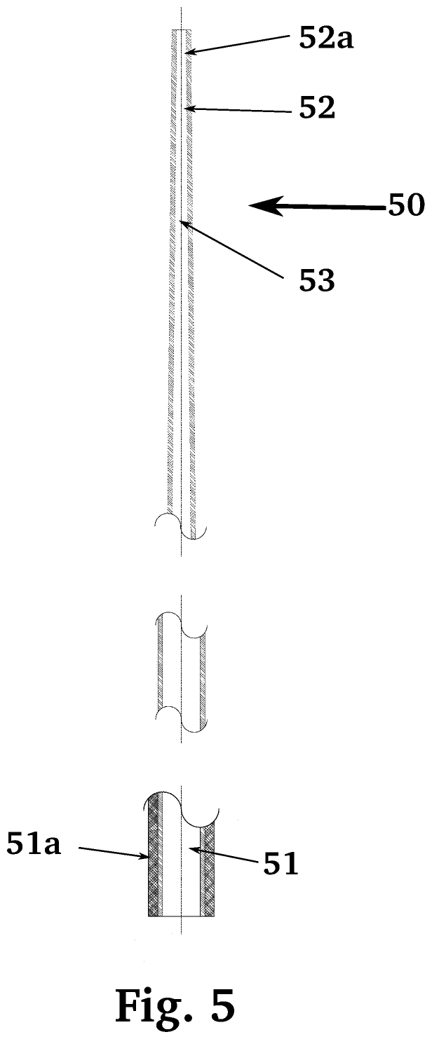

Referring now to the Drawing, wherein FIG. 1 is a perspective view of a typical prior art gaff generally 10 comprising a metallic head 12 having a centrally disposed body 13 preferably, shown herein in the shape of a semi-circle, and further having at the distal end 14 a “prong” or pointed first projection 15 for engaging the fish, and a second projection element 16 at the proximal end 18 thereof for securement to a handle, as shown below in FIGS. 4 and 5.

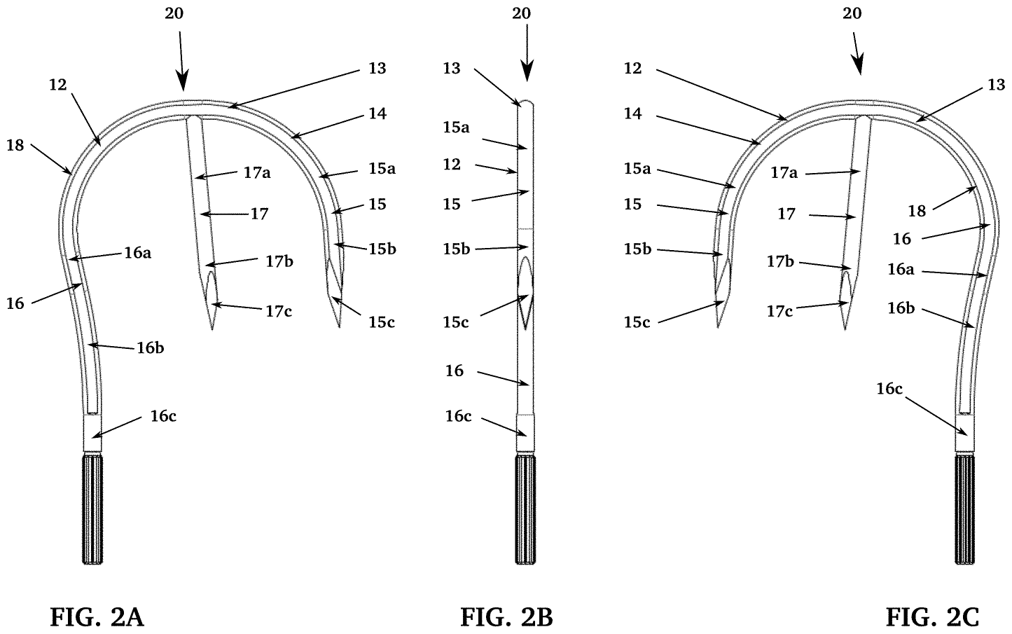

FIGS. 2A, 2B, 2C show one preferred emblement of the improved multi-prong gaff generally 20 of the present invention for immobilizing a caught fish. As with the prior art gaff 10 of FIG. 1, gaff 20 comprises a metallic head 12 having a centrally disposed body 13, which is herein shown as one embodiment in the shape substantially of a semi-circle (although other shapes may be utilized, including for example, squared, angled or elliptical or oval shapes). Body 13 yet further has disposed at each end 14, 18 thereof first and second projections 15, 16 emanating substantially in a “hook-shape” therefrom. As used herein, the term “hook-shaped” means angling-away or curving-away in a substantially transverse direction from body 13, as opposed to projecting in a substantially longitudinal direction therefrom in a straight or parallel line, for example such as with a hay-fork, rake, trident or frog-gig, as those terms are recognized by those of ordinary skill in the art.

One or more of the projections 15, 16 may be smooth or may be ribbed for greater frictional engagement—either with the gaffed fish at the distal end 14, or with the handle at the proximal end 18.

Pointed first projection 15 is connected to body 13 at proximal end 15a thereof and at the distal end 15b thereof bears a point 15c. Second projection 16 is connected at the proximal end 16a thereof to body 13 and at the distal end 16b has a handle connection portion 16c. As shown, handle connection portion 16c may be curved slightly inwardly towards first projection portion 15.

Unlike the prior art, preferred emblement of the improved multi-prong gaff 20 of the present invention includes at least one pointed immobilizing projection 17 disposed internally of pointed first projection 15 within body 13 and projecting at a selected functional angle which may be substantially parallel to first and second projections 15,16 in some preferred embodiments. Projections 15, 17 may be of varying diameter and length, and may in some embodiments be of substantially equal diameter and length, as shown in FIG. 1. In some alternative embodiments, one or more of projections 15, 17 may be curved inwardly towards projection 16. Second projection 16 is preferably extended in length at the distal end thereof. In some preferred embodiments, the at least one pointed immobilizing projection(s) 17 may be connected directly to body 13 at proximal end 17a, and has disposed at the distal end 17b thereof point 17c.

In other alternative embodiments, body 13, first projection 15, and a single pointed immobilizing projection 17 may preferably be formed from a single metal rod that has been folded-back upon itself in a lateral direction at a selected point along the length thereof, and with first projection 15 and a single pointed immobilizing projection 17 formed thereon by bending the rod at the respective ends thereof in a substantially perpendicular direction. Accordingly, in this alternative embodiment, the gaff 20 contains two functional projections 15, 17 that are disposed in side-by-side relationship or alternatively are bent to lie within the same plane, and are secured onto a single handle, thereby for essentially simultaneous gaffing of the caught fish by both such pointed projections.

Head 12 may be cylindrical, or other cross-sectional shapes, and is preferably formed from metal rod, preferably including steel rod, and wherein the first and second projections 15, 16 are unitarily formed. Such metal rod may be, for example, ½ or ⅜ inch thick stainless steel. Head 12 may also be hollow and wherein first projection 15 and at least one pointed immobilizing projection 17 are formed from sharpened metal rod and affixed to head 12—for example, by threading thereon and within selected through-holes disposed in hollow head 12, thereby to provide selectability and adjustability of spacing between at least one pointed immobilizing projection 17 and first projection 15.

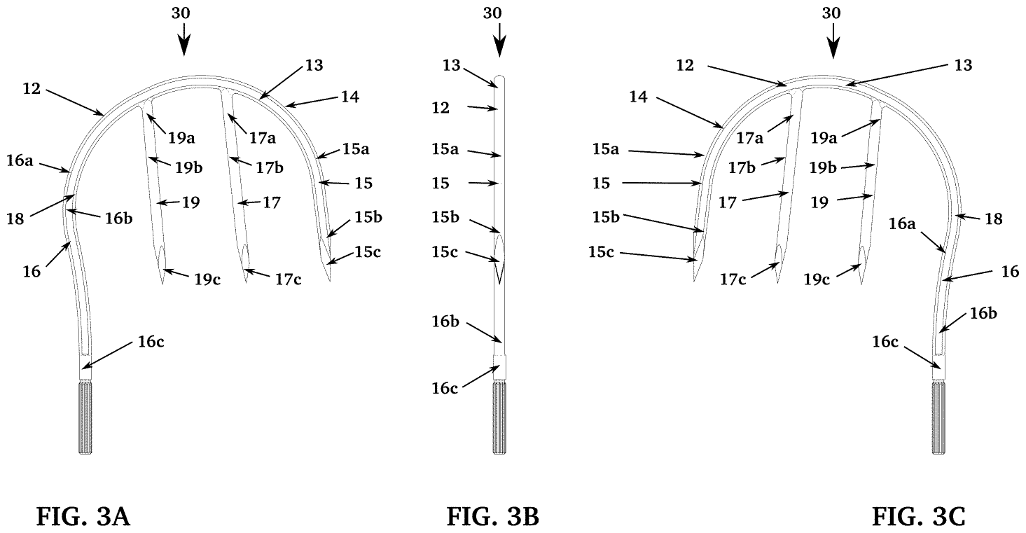

FIGS. 3A, 3B, 3C show an alternative preferred emblement of the improved multi-prong gaff generally 30 for immobilizing a caught fish similar to the embodiments of FIGS. 2A, 2B, 2C, but having a second immobilizing projection. Thus, in FIGS. 3A, 3B, 3C, and as with the prior art gaff of FIG. 1, gaff 30 comprises a metallic head 12 having a centrally disposed body 13 shown herein substantially in the shape of a semi-circle, and further having disposed at each end 14, 18 of said semi-circular body 13 first and second projections 15, 16 emanating substantially tangentially therefrom. One or more of the projections 15, 16 may be smooth, or may be ribbed for greater frictional engagement, either with the gaffed fish at distal end 14 or with the handle at proximal end 18.

Pointed first projection 15 is connected to body 13 at proximal end 15a thereof and at the distal end 15b thereof bears a point 15c. Second projection 16 is connect at the proximal end 16a thereof to body 13 and at the distal end 16b has a connection portion 16c, which may include a ribbed exterior surface to facilitate securement within a hollow handle, for example.

Like the embodiment of FIGS. 2A, 2B, 2C, the preferred embodiment of the improved multi-prong gaff 30 of the present invention, includes at least one immobilizing projection 17 disposed internally of pointed first projection 15 within body 13 and projecting substantially parallel to first and second projections 15, 16. The at least one pointed immobilizing projection 17 is connected to body 13 at proximal end 17a, and has disposed at the distal end 17b thereof a point 17c. However, the gaff 30 of the present invention, includes an additional pointed immobilizing projection 19 disposed internally of pointed first projection 15 within body 13 and projecting substantially parallel to first and second projections 15, 16. The at least one pointed immobilizing projection 19 is connected to body 13 at proximal end 19a, and has disposed at the distal end 19b thereof a point 19c.

FIG. 4 shows the yet further preferred embodiment of the improved multi-prong fishing gaff of the present invention generally 40, and in particular shows a reinforcing member 41 attached to the body of the gaff 40, and carrying thereon a pointed immobilizing projection 42.

The pointed immobilizing projection members 17, 19 and the reinforcing member 41 may be attached to body 13 by any suitable technique known to those of ordinary skill in the prior art, including preferably by means of welding thereto—including, for example, fusion welding, pressure welding and brazing/soldering. However, bolting, riveting, caulking, shrink fitting, and folding may also be used as may be appropriate for joinder of these metallic structures.

FIG. 5 shows one form of a suitable handle generally 50, which may be of several alternative designs. Handle 50 may be tapered, as shown, to provide a larger grip surface for a more secure grip at the proximal end 51 thereof, and which may also include a grip 51a formed from a grippable material, such as rubber, fabric or cord wrapping. The distal end 52 may be of smaller dimension to provide greater facility and maneuverability in gaffing the fish.

Handle 50 has at the proximal end 51 thereof a grasping portion 51a disposed for gasping manually in order to manipulate the head for carrying out a gaffing function, and deposed at the distal end 52 thereof is a connection portion 52a. Connection portion 52a may be secured to gaff body 13 by any means known to those of ordinary skill in the art, such as by pins 54, as shown in FIG. 4, or alternatively by welding, friction fit, screw-fit, pressure fit, or other prior art attachment means.

In one preferred embodiment, as shown in FIG. 5, handle generally 50 may have a hollow interior 53, which may permit it to float, if dropped in the water. Handle 50 may be constructed of high strength plastic or metal, including aluminum or fiberglass. Handle 50 may also be solid and constructed of a floatable wood or plastic material.

Accordingly, a fish may preferably be gaffed according to the steps of

hooking the fish with a first gaff hook, while substantially simultaneously hooking the fish with at least one second gaff hook for holding and immobilizing the fish.

The improved gaffs of the present invention, as shown, may have two or more engaging prongs 17, 19 that can be each approximately 7 inches long. Other lengths of prongs may be used depending on the expected size and strength of the fish, such as for example 5 inches or 9 inches. Typically, the larger the fish, the longer the prong should be. As shown, the prongs 17, 19 are arrayed along the inner curve of the gaff body and directed backwardly in the direction of handle 50.

As shown in these exemplary embodiments, the inner curve of the gaff body 13 may have a lateral length of approximately 11 inches, although other lengths may be appropriate for different sized fish. This alignment allows the gaff body to be deployed beneath the fish, jerked upwards to pierce the fish, and pulled back into the boat.

The “strongback” support structure of the present invention comprising gaff body 13 is configured to provide support when the fish is being hoisted out of the water. A large fish will cause the gaff to flex downward, causing the hook shape of the gaff body to straighten. This flex will allow the fish to escape more easily. The strongback prevents the gaff from flexing by providing support to the curve of the gaff.

Handle 50, as shown, is approximately 8 feet in length, but other sizes may be used depending on the size of the boat. Larger boats may require longer handles to reach the water, and smaller boats may use a shorter handle. The handle has a rubber or other greppable surface 51a affixed to the end thereof to allow for a more secure grip for the fisher. Exemplary handle lengths may be 6, 8, 10, or 12 feet.

As an example, handle 50 may be composed of 1-1.5 inch aluminum, carbon fiber, wood, or any other suitable material. Handle 50 must be durable enough to support the weight of the fish being cause while being light enough to be handled by a single fisher.

It therefore can be seen that the structure of the improved multi-prong gaff and the associated methods according to the principles of the present disclosure provide for enhanced immobilization for greater security in landing a hooked fish.

Those skilled in the art will appreciate that many modifications to the exemplary embodiments are possible without departing from the scope of the invention. In addition, it is possible to use some of the features of the embodiments described without the corresponding use of the other features. Accordingly, the foregoing description of the exemplary embodiments is provided for the purpose of illustrating the principle of the invention, and not in limitation thereof, since the scope of the invention is defined solely be the appended claims.

What is claimed is:

1. An improved multi-prong gaff for immobilizing a caught fish, said gaff comprising:
a metallic head having a centrally disposed body and further having:
a. first and second projections, disposed at each end of said body, emanating in a substantially hook-shape therefrom, with said first projection connected to said body at the proximal end thereof and bearing a point at the distal end thereof, and said second projection connected at the proximal end thereof to said body and having a connection portion disposed at the distal end thereof; and
b. at least one immobilizing projection carried by said head and projecting inwardly of the body and substantially parallel to said first and second projections, said at least one immobilizing projection having a point at the distal end thereof; and
a handle having a connection portion disposed at the distal end thereof and a grasping portion disposed at the proximal end thereof for gasping manually in order to manipulate the head for carrying out an immobilizing gaffing function.

2. The improved multi-prong gaff for immobilizing a caught fish of claim 1, wherein said at least one immobilizing projection carried by said body.

3. The improved multi-prong gaff for immobilizing a caught fish of claim 1, wherein said head is substantially in the shape of a semi-circle, and said first and second projections, disposed at each end of said body, emanating substantially tangentially therefrom.

4. The improved multi-prong gaff for immobilizing a caught fish of claim 1, wherein said head is formed from metal.

5. The improved multi-prong gaff for immobilizing a caught fish of claim 1, wherein said head is substantially cylindrical in cross-sectional shape.

6. The improved multi-prong gaff for immobilizing a caught fish of claim 1, wherein said head is formed from steel rod.

7. The improved multi-prong gaff for immobilizing a caught fish of claim 1, wherein said head and said first and second projections are unitarily formed.

8. The improved multi-prong gaff for immobilizing a caught fish of claim 1, wherein said head and said first and second projections are separately formed.

9. The improved multi-prong gaff for immobilizing a caught fish of claim 7, wherein said head is hollow and wherein said first projection and said at least one pointed immobilizing projection are formed from sharpened meatal rod and affixed to said head for projecting inwardly thereof.

10. The improved multi-prong gaff for immobilizing a caught fish of claim 8, wherein said first projection and said at least one pointed immobilizing projection are affixed to said head within selected through-holes in said hollow head, thereby to provide selectability and adjustability of spacing between said at least one pointed immobilizing projection and said first projection.

11. The improved multi-prong gaff for immobilizing a caught fish of claim 1, wherein said second projection is extended in length at the distal end thereof.

12. The improved multi-prong gaff for immobilizing a caught fish of claim 1, wherein said handle is formed from a material less dense than the head.

13. The improved multi-prong gaff for immobilizing a caught fish of claim 1, wherein said handle is hollow.

14. The improved multi-prong gaff for immobilizing a caught fish of claim 1, wherein said at least one immobilizing projection is a single immobilizing projection.

15. The improved multi-prong gaff for immobilizing a caught fish of claim 1, wherein said at least one immobilizing projection includes at least one additional immobilizing projection.

16. The improved multi-prong gaff for immobilizing a caught fish of claim 1, wherein said body further includes a reinforcing member attached to the body of the gaff and bearing thereon at least one immobilizing projection.

17. The improved multi-prong gaff for immobilizing a caught fish of claim 1, wherein said body, said first projection, and a single said pointed immobilizing projection are formed from a single metal rod that has been folded-back upon itself in a lateral direction at a selected point along the length thereof.

18. The improved multi-prong gaff for immobilizing a caught fish of claim 17, wherein said, first projection and said single pointed immobilizing projection are formed thereon by bending said rod at the respective ends thereof in a substantially perpendicular direction.

19. The improved multi-prong gaff for immobilizing a caught fish of claim 18, wherein said gaff contains two said functional projections that are disposed in side-by-side relationship, and are secured onto a single handle, thereby for essentially simultaneous gaffing of the caught fish by both said pointed projections.

20. A method for immobilizing a caught fish, said method comprising the steps of:
a. hooking the fish with a first gaff hook,
b. while substantially simultaneously hooking the fish with a second gaff hook for holding and immobilizing the fish.
